(19) United States
(12) Patent Application Publication
(10) Pub. No.: US 2024/0401618 A1
(43) Pub. Date: Dec. 5, 2024

(54) SYSTEM AND METHOD FOR ADJUSTING A VALVE

(71) Applicant: LIEBHERR-AEROSPACE LINDENBERG GMBH, Lindenberg (DE)

(72) Inventor: Martin DOHRING, Lindenberg (DE)

(73) Assignee: LIEBHERR-AEROSPACE LINDENBERG GMBH, Lindenberg (DE)

(21) Appl. No.: 18/675,204

(22) Filed: May 28, 2024

(30) Foreign Application Priority Data
May 30, 2023 (DE) 10 2023 114 143.0

(51) Int. Cl. F15D 1/02; F16K 99/00

(52) U.S. Cl. CPC F15D 1/025; F16K 99/00

(57) ABSTRACT

The present invention relates to a system for adjusting a valve, in particular a servo valve, wherein the valve comprises a nozzle and a flow divider, with a positioning unit which is configured to position the nozzle relative to the flow divider, a measuring unit which is configured to determine a pressure and/or flow rate in at least one line branching off from the flow divider, and a control unit which is configured to control the positioning unit to position the nozzle relative to the flow divider based upon a pressure and/or flow rate determined by the measuring unit, and a control unit which is configured to control the positioning unit based upon a pressure and/or flow rate determined by the measuring unit in order to position the nozzle relative to the flow divider in such a way that a desired pressure and/or flow rate results in the at least one line.

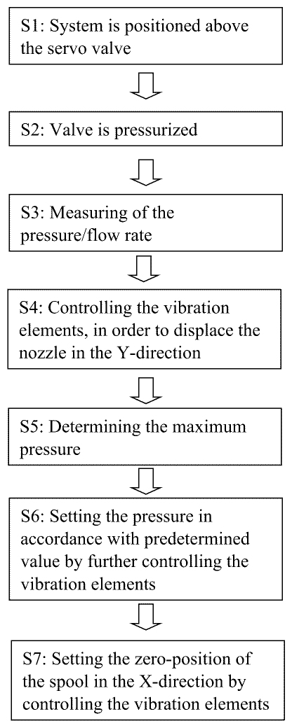

### CROSS-REFERENCE TO RELATED APPLICATIONS

The present application claims priority to German Patent Application No. 10 2023 114 143.0, filed May 30, 2023, which is incorporated in its entirety by reference herein.

### BACKGROUND OF THE INVENTION

The present invention relates to a system and a method for the preferably automated or automatable adjustment of a valve, in particular a servo valve.

Servo valves comprise a nozzle and a flow divider, or jet splitter, which splits a fluid jet emitted by the nozzle. When manufacturing such servo valves, the nozzle must be positioned precisely with respect to the flow divider in order to achieve the desired division of the jet. This relative positioning of the nozzle to the flow divider is preferably to be understood as an adjustment of the valve.

In the prior art, servo valves are set manually by an operator. The nozzle is positioned over the jet divider by lightly tapping it with a hammer and chisel. The adjustment is effected based upon pressures and/or flow rates which are measured and output by a test bench. Depending on the pressure and/or flow rate determined, the operator must tap the nozzle in one direction or the other. During this process, the servo valve is under operating pressure so that the operator has to tap on a pressurized component. This is disadvantageous in terms of safety.

In addition, a manual adjustment process always includes a subjective component, which makes it difficult to standardize the process. Furthermore, manual processes cannot be automated.

### SUMMARY OF THE INVENTION

Against this background, the present invention is based on the object of mitigating or even completely eliminating the problems occurring in the prior art. In particular, the present invention is based on the object of providing a safe, reliable and automatable way of adjusting or setting a valve.

This object is achieved by means of a system and a method according to the independent claims. Advantageous further embodiments of the invention are specified in the dependent claims.

### BRIEF DESCRIPTION OF THE DRAWINGS

The FIGURE is a flow chart, which provides features and effects of the present invention. The FIGURE discloses a control logic according to which the control unit of a system according to the invention regulates the positioning of the nozzle.

### DETAILED DESCRIPTION

Accordingly, a system for adjusting a valve is provided, in particular a servo valve, wherein the valve comprises a nozzle and a flow divider; comprising a positioning unit which is configured to position the nozzle relative to the flow divider, a measuring unit which is configured to determine a pressure and/or flow rate in at least one line branching off from the flow divider, and a control unit which is configured to control the positioning unit based upon a pressure and/or flow rate determined by the measuring unit in order to position the nozzle relative to the flow divider in such a way that a desired pressure and/or flow rate results in the at least one line.

According to the invention, the nozzle is thus positioned automatically by a control loop between the measuring unit, which measures the pressure and/or flow rate, and the positioning unit, which positions the nozzle.

Preferably, the control unit is configured to compare the measured pressure and/or flow rate with a target value and to generate a control command for the positioning unit based on the difference.

The measuring unit can be configured to determine a pressure and/or flow in two lines branching off from the flow divider, wherein the control unit is configured to determine a pressure difference and/or flow difference between the two lines and to control the positioning unit based upon the pressure difference and/or flow difference.

For example, the control unit can be configured to control the positioning unit to position the nozzle relative to the flow divider in such a way that the pressure difference and/or flow difference between the two lines is zero.

In other words, the control unit can be configured to control the positioning unit to position the nozzle centrally above the flow divider so that the same pressure and/or flow rate is created in the two lines branching off from the flow divider.

The invention is of course not limited to two branching lines; there can also be several lines.

According to one embodiment, the positioning unit may comprise four positioning elements which are operatively connected to the nozzle in order to move or displace the nozzle along two right-angled axes. For example, two positioning elements can move the nozzle up and down and two positioning elements can move the nozzle to the right and to the left.

Some or all of the positioning elements can be configured as vibration elements, which are configured to move the nozzle or a support structure of the nozzle, in particular a base plate of the nozzle, by vibration.

Furthermore, at least one positioning element, preferably all positioning elements, each comprise a displacing element which is configured to press the positioning element against the nozzle or a support structure of the nozzle.

At least one displacing element, preferably all displacing elements, can be pneumatically and/or electrically adjustable or controllable.

In other words, vibrating elements can be provided which pneumatically and/or electrically press against the base plate of the servo valve, for example, via servomotors with a certain preload or a certain contact pressure (which can preferably be regulated via the pneumatic pressure and/or the energization of the servomotors).

Preferably, in a system according to the invention, only the positioning unit controlled by the control unit moves the nozzle and the system is not set up for manual positioning of the nozzle. A system according to the invention can therefore be used to adjust a valve automatically and without manual human intervention.

A further aspect of the present invention relates to a use of a system according to the invention for manufacturing an aircraft, in particular an airplane, or a component thereof, in particular a valve, for example a servo valve.

Another aspect of the present invention relates to a method of adjusting a valve, wherein the method preferably is carried out by means of a system according to the invention, comprising the steps of: positioning a nozzle of the valve above a flow divider of the valve, applying pressure to the valve, determining a pressure and/or flow rate in at least one line branching off from the flow divider, and automatically actuating the positioning unit by means of a control unit based upon the determined pressure and/or flow rate in order to position the nozzle relative to the flow divider in such a way that a desired pressure and/or flow rate results in the at least one line.

At this point, it should be noted that all features disclosed in the context of a system according to the invention are also applicable to a method according to the invention, although an explicit disclosure herein has been omitted for reasons of avoiding redundancy.

Preferably, the method is used in the manufacture of an aircraft, in particular an airplane, or a component thereof, in particular a valve.

In a method according to the invention, the nozzle can be positioned relative to the flow divider exclusively by the positioning unit and without manual intervention.

Further advantages, features and effects of the present invention are specified in the following description and in the FIGURE, which discloses a control logic according to which the control unit of a system according to the invention regulates the positioning of the nozzle.

In step S1, a system according to the invention first positions itself over the valve to be adjusted so that the nozzle of the valve can be positioned by means of the positioning unit.

In step S2, the valve is applied with pressure by the application of a fluid.

In step S3, pressure and/or flow rate is/are measured in a line downstream of the flow divider of the valve. The measured value is compared with a setpoint value and the vibration elements of the positioning unit are controlled accordingly in step S4 in order to move the nozzle in the Y direction.

In step S5, a maximum pressure is then detected in the line downstream of the flow divider of the valve.

In step S6, the vibration elements of the positioning unit are then actuated accordingly in order to move the nozzle in the Y direction until the determined pressure corresponds to a setpoint value or default value.

Finally, in step S7, the positioning of the nozzle in the X direction is adjusted by controlling the vibration elements accordingly.

What is claimed is:

1. A system for adjusting a valve, wherein the valve comprises a nozzle and a flow divider;
said system comprising:
a positioning unit which is configured to position the nozzle relative to the flow divider,
a measuring unit which is configured to determine a pressure and/or a flow rate in at least one line branching off from the flow divider, and
a control unit which is configured to control the positioning unit based upon a pressure and/or flow rate determined by the measuring unit in order to position the nozzle relative to the flow divider in such a way that a desired pressure and/or flow rate results in the at least one line.

2. The system according to claim 1, wherein the measuring unit is configured to determine a pressure and/or flow rate in two lines branching off from the flow divider, wherein the control unit is configured to determine a pressure difference and/or flow rate between the two lines and to control the positioning unit based upon the pressure difference and/or flow rate.

3. The system according to claim 2, wherein the control unit is configured to control the positioning unit to position the nozzle relative to the flow divider such that the pressure difference and/or flow rate between the two lines is zero.

4. The system according to claim 1, wherein the positioning unit comprises four positioning elements which are operatively connected to the nozzle for moving or displacing the nozzle along two right-angled axes.

5. The system according to claim 4, wherein the positioning elements are configured as vibration elements which are configured to move the nozzle or a support structure of the nozzle by vibration.

6. The system according to claim 4, wherein at least one positioning element comprises a displacing element which is configured to press the positioning element against the nozzle or a support structure of the nozzle.

7. The system according to claim 6, wherein at least one displacing element is capable of being regulated and/or controlled in a pneumatical and/or electrical manner.

8. The system according to claim 1, wherein only the positioning unit controlled by the control unit moves the nozzle and the system is not set up for manual positioning of the nozzle.

9. A method for manufacturing an aircraft or a component thereof, said method comprising utilizing the system of claim 1.

10. A method of adjusting a valve, wherein the method is carried out by means of the system according to claim 1, said method comprising the steps of:
positioning a nozzle of the valve above a flow divider of the valve,
applying pressure to the valve,
determining a pressure and/or a flow rate in at least one line branching off from the flow divider
automatically controlling the positioning unit based upon the determined pressure and/or flow rate in order to position the nozzle relative to the flow divider in such a way that a desired pressure and/or flow rate results in the at least one line.

11. The method according to claim 10, wherein the method is used in the manufacture of an aircraft or a component thereof.

12. The method according to claim 10, wherein the nozzle is positioned exclusively by the positioning unit and without manual intervention.

13. The system of claim 1, wherein the valve is a servo valve.

14. The system according to claim 4, wherein the positioning elements are configured as vibration elements which are configured to move the nozzle or a support structure of a base plate of the nozzle, by vibration.

15. The system according to claim 4, wherein all positioning elements comprise a displacing element which is configured to press the positioning element against the nozzle or a support structure of the nozzle.

16. The system according to claim 6, wherein all displacing elements are capable of being regulated and/or controlled in a pneumatical and/or electrical manner.

17. The method of claim 11, wherein the component is at least one valve.

18. A method of adjusting a valve, said method comprising the steps of:
positioning a nozzle of the valve above a flow divider of the valve,
applying pressure to the valve,
determining a pressure and/or a flow rate in at least one line branching off from the flow divider
automatically controlling the positioning unit based upon the determined pressure and/or flow rate in order to position the nozzle relative to the flow divider in such a way that a desired pressure and/or flow rate results in the at least one line.
